(19) United States
(12) Patent Application Publication
(10) Pub. No.: US 2024/0110549 A1
(43) Pub. Date: Apr. 4, 2024

(54) FRICTIONLESS DESIGN OF HIGH-PRESSURE RECIRCULATION THERMO-PUMP

(71) Applicant: KLA Corporation, Milpitas, CA (US)

(72) Inventor: Anatoly Shchemelinin, Bozeman, MT (US)

(73) Assignee: KLA Corporation, Milpitas, CA (US)

(21) Appl. No.: 18/368,242

(22) Filed: Sep. 14, 2023

Related U.S. Application Data
(60) Provisional application No. 63/411,115, filed on Sep. 29, 2022.

(51) Int. Cl. F03G 7/06; H01J 61/28

(52) U.S. Cl. CPC F03G 7/0646; H01J 61/28

(57) ABSTRACT

A thermo-pump includes a sealed casing, divided into a main casing volume and one or more secondary volumes. A thermo-pump includes a shaft. A thermo-pump includes a displacer, coupled to the shaft and oscillates to create a pressure gain between a high-pressure phase and a low-pressure phase. A thermo-pump includes one or more displacer rings, wherein the displacer rings are made from a material with thermal properties below a threshold. A thermo-pump includes an insert, wherein the insert is configured to form a perimeter of the main casing volume, wherein the insert is made from a material with thermal properties below the threshold. A thermo-pump includes one or more bushings, wherein the one or more bushing separate the main casing volume and the one or more secondary volumes. A thermo-pump includes one or more gas bearings configured to prevent contact between the shaft and the sealed casing.

### CROSS-REFERENCE TO RELATED APPLICATION

The present application claims the benefit under 35 U.S.C. § 119(e) of U.S. Provisional Application Ser. No. 63/411,115, filed Sep. 29, 2022, which is incorporated herein by reference in the entirety.

### TECHNICAL FIELD

The present disclosure relates generally to thermo-pump systems, and more particularly, to frictionless operation of thermo-pumps.

### BACKGROUND

Various types of bearings may be used to keeps shafts from making contact with the side of a casing. However, many of the bearings used are not suitable for operating in clean and/or high-pressure environments because of a necessity of lubrication or suitable pressure differences. Operating traditional bearing systems in clean and/or high-pressure environments may result in significant reduction in part life due to excess friction, or otherwise unideal conditions for part wear. Therefore, there is a need to provide a solution that provides suitable shaft stability and lifetime in a clear and/or high-pressure environment.

### SUMMARY

A thermo-pump is disclosed, in accordance with embodiments of the present disclosure. In embodiments, the thermo-pump includes a sealed casing, wherein the sealed casing is divided into a main casing volume and one or more secondary volumes. In embodiments, the thermo-pump includes a shaft, wherein the shaft is configured to be driven to cause the shaft to linearly oscillate within the sealed casing. In embodiments, the thermo-pump includes a displacer, wherein the displacer is coupled to the shaft and oscillates within the main casing volume based on oscillation of the shaft, wherein oscillation of the displacer creates a pressure gain between a high-pressure phase and a low-pressure phase. In embodiments, the thermo-pump includes one or more displacer rings, wherein the one or more displacer rings are coupled to the displacer and extend radially outward into the main casing volume, wherein the one or more displacer rings are made from a displacer ring material selected to have at least one of a displacer ring thermal conductivity coefficient or a displacer ring thermal expansion coefficient below a threshold. In embodiments, the thermo-pump includes an insert, wherein the insert is configured to form a perimeter of the main casing volume, wherein the insert is made from an insert material selected to have at least one of an insert thermal conductivity coefficient or an insert thermal expansion coefficient below the threshold, wherein the one or more displacer rings and the insert direct a gas through the displacer. In embodiments, the thermo-pump includes one or more bushings, wherein the one or more bushing separate the sealed casing into the main casing volume and the one or more secondary volumes. In embodiments, the thermo-pump includes one or more gas bearings configured to prevent contact between the shaft and the sealed casing, wherein the one or more gas bearings are configured to operate based on the high-pressure phase and the low-pressure phase created by pressure oscillations caused by the oscillation of the displacer.

A system is disclosed, in accordance with embodiments of the present disclosure. In embodiments, the system includes a broadband plasma light source. In embodiments, the system includes a thermo-pump configured to provide pressurized gas to a broadband plasma light source. In embodiments, the thermo-pump includes a sealed casing, wherein the sealed casing is divided into a main casing volume and one or more secondary volumes. In embodiments, the thermo-pump includes a shaft, wherein the shaft is configured to be driven to cause the shaft to linearly oscillate within the sealed casing. In embodiments, the thermo-pump includes a displacer, wherein the displacer is coupled to the shaft and oscillates within the main casing volume based on oscillation of the shaft, wherein oscillation of the displacer creates a pressure gain between a high-pressure phase and a low-pressure phase. In embodiments, the thermo-pump includes one or more displacer rings, wherein the one or more displacer rings are coupled to the displacer and extend radially outward into the main casing volume, wherein the one or more displacer rings are made from a displacer ring material selected to have at least one of a displacer ring thermal conductivity coefficient or a displacer ring thermal expansion coefficient below a threshold. In embodiments, the thermo-pump includes an insert, wherein the insert is configured to form a perimeter of the main casing volume, wherein the insert is made from an insert material selected to have at least one of an insert thermal conductivity coefficient or an insert thermal expansion coefficient below the threshold, wherein the one or more displacer rings and the insert direct a gas through the displacer. In embodiments, the thermo-pump includes one or more bushings, wherein the one or more bushing separate the sealed casing into the main casing volume and the one or more secondary volumes. In embodiments, the thermo-pump includes one or more gas bearings configured to prevent contact between the shaft and the sealed casing, wherein the one or more gas bearings are configured to operate based on the high-pressure phase and the low-pressure phase created by pressure oscillations caused by the oscillation of the displacer.

A method of thermo-pump operation is disclosed, in accordance with embodiments of the present disclosure. In embodiments, the method includes isolating, by one or more bushings, one or more secondary volumes from a main casing volume. In embodiments, the method oscillating a displacer coupled to a shaft in order to vary a pressure within the main casing volume, wherein the thermo-pump has a high-pressure phase and a low-pressure phase caused by oscillating the displacer. In embodiments, the method supplying at least a first portion of the high-pressure phase of the thermo-pump to a broadband plasma light source. In embodiments, the method supplying at least a second portion of the high-pressure phase of the thermo-pump to one or more gas bearings located within each of the one or more secondary volumes. In embodiments, the method preventing, by the one or more gas bearings, contact between the shaft and a casing of the thermo-pump. In embodiments, the method directing, by one or more displacer rings and an insert within the thermo-pump, a gas through the displacer, wherein the gas directed through the displacer creates the high-pressure phase of the thermo-pump, wherein the one or more displacer rings are coupled to the shaft and extend radially outward into the main casing volume, wherein the displacer rings are made from a displacer ring material selected to have at least one of a displacer ring thermal conductivity coefficient or a displacer ring thermal expansion coefficient below a threshold, wherein the insert is configured to form a perimeter of the main casing volume, wherein the insert is made from an insert material selected to have at least one of an insert thermal conductivity coefficient or an insert thermal expansion coefficient below the threshold.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF DRAWINGS

The numerous advantages of the disclosure may be better understood by those skilled in the art by reference to the accompanying figures.

FIG. 1 is a cross-section schematic of a thermo-pump, in accordance with one or more embodiments of the present disclosure.

FIG. 2 is a block diagram of a system, in accordance with one or more embodiments of the present disclosure.

FIG. 3 is a flow diagram of a method, in accordance with one or more embodiments of the present disclosure.

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

Extended operation of a piston and/or a linear shaft in a clean and sealed (e.g., a pressurized) environment may cause problems. Typical solutions for pistons (e.g., in applications such as engines, piston pumps, or the like) include bearings (e.g., ball bearings) and/or bushings. The bearings and/or bushings may require active lubrication (e.g., grease) in order to extend their life and prevent issues caused by excessive friction. However, lubrication appropriate for non-clean environments (e.g., grease) may not be appropriate for use in clean environments. Thus, bearings and/or bushings operating in a clean environment may use dry lubricants or no lubrication. However, bearings and/or bushings using dry lubricants or no lubrication may experience significantly limited lifespans.

In certain applications, magnetic bearings may be used to provide frictionless stabilization suitable for clean environments. However, applications of magnetic bearings are generally limited to rotational stabilization. At times, magnetic bearings may be adapted for other uses, however, adaptation of magnetic bearings for uses relating to linear shaft stabilization may be prohibitively difficult.

Similarly, traditional piston rings (e.g., for sealing a piston and compensating for thermal expansion) may likewise have issues operating in conjunction with a thermo-pump in a clean environment. Typically, precise mechanical systems (there are no clean mechanical piston pumps) that are designed to operate in a clean environment use temperature stabilization to minimize expansion, and consequently limit gaps between moving components. Also, the use of no-lubricants operation is common, but that results in reduction of the lifetime below reasonable for given applications. However, for thermo-pumps, such temperature stabilization is not possible due to the requisite temperature difference between hot and cold sides of the sealed casing. Finally, the use of very clean vacuum compatible grease is not possible for the temperature range associated with the operation of the thermo-pump. Thus, traditional piston rings may be inappropriate for uses relating to thermo-pumps.

The present disclosure discloses systems for operating a thermo-pump in a clean and high-pressure environment with a significantly increased lifespan, particularly when compared to the other techniques described previously herein. More specifically, this disclosure presents a thermo-pump with frictionless linear shaft operation in a clean, high-pressure environment. Such a thermo-pump may be used in conjunction with a broadband plasma (BBP) flow-through based light source. More broadly speaking, the thermo-pump may be used with a plasmatron light source (e.g., a light source where plasma is placed in a gas flow (e.g., a wind tunnel)).

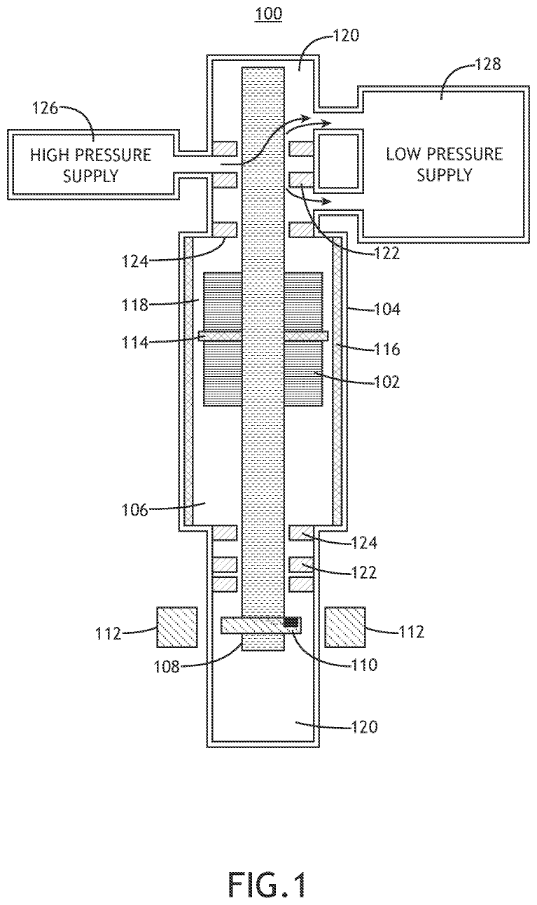

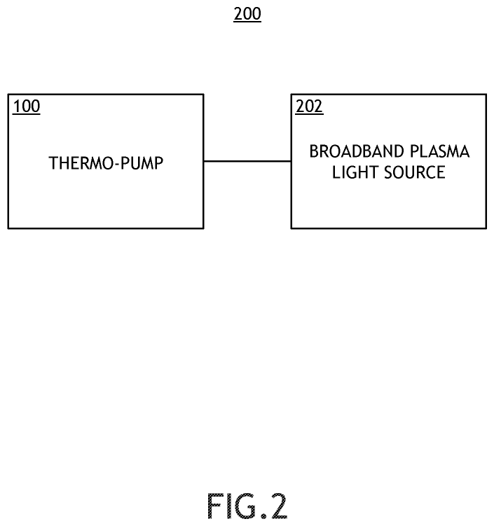

Referring now to FIGS. 1-2, implementations of a frictionless thermo-pump 100 suitable for use in a clean and high-pressure environment are disclosed, in accordance with one or more embodiments of the present disclosure.

FIG. 1 is a cross-section schematic of the thermo-pump 100, in accordance with one or more embodiments of the present disclosure. Possible designs for thermo-pumps are disclosed in U.S. Pat. No. 11,450,521, issued on Sep. 20, 2022, which is incorporated herein by reference in its entirety.

In embodiments, the thermo-pump 100 includes a displacer 102 within a sealed casing 104. The displacer 102 may be a body configured to move linearly (e.g., up and down) within the sealed casing 104. The displacer 102 may be designed to allow gas flow through it, for example by incorporating channels. The displacer 102 may further include one or more channels (e.g., vertical channels). For example, the channels may be designed to allow the flow of gases through the channel when the thermo-pump 100 is in operation (e.g., when the displacer 102 is oscillating). The displacer 102 may combine two functions: isolating gas in hot and cold ends of the sealed casing 104 and providing heat exchange with the gas passing through it. To meet these requirements, the displacer 102 is often made of several components, one of which may be a regenerator (not pictured) (e.g., a relatively small part that has high thermal conductivity and high thermal capacity and is placed at the core of the displacer 102), while the rest of the displacer 102 may be made from a lightweight material that displays low thermal conductivity and low thermal capacity. In embodiments, the regenerator may be made of multi-layered copper mesh. Further, the displacer 102 may be made from a material that has a high thermal expansion coefficient. Because the displacer 102 may have low thermal conductivity and capacity and has a high thermal expansion coefficient, the displacer 102 may exhibit relatively large thermal expansion during operation of the thermo-pump 100. As a nonlimiting example, the displacer 102 may be made from Teflon. In this way, the displacer 102 may include components with various thermal conductivities (e.g., the regenerator may have a high thermal capacity and the rest of the displacer 102 may have a low thermal capacity). It should be noted that for the purposes of the present application the displacer 102 will be referred to as a whole, instead of with reference to the individual components.

The displacer 102 may be configured to move a gas between hot and cold ends of the sealed casing 104. Moving the gas between the hot and cold ends of the sealed casing 104 may create a pressure gain between a high-pressure phase and a low-pressure phase.

In embodiments, the thermo-pump 100 includes a sealed casing 104. The sealed casing 104 may enclose a main casing volume 106, through which the displacer 102 linearly translates. The sealed casing 104 may have a significant temperature difference on either side of the sealed casing 104 (e.g., the top of the sealed casing 104 may be very cold and the bottom of the sealed casing 104 may be very hot, or vice versa). The large temperature difference between the two sides of the sealed casing 104 may cause significant thermal expansion. It should be noted that because the displacer 102 does not create a large pressure drop with its oscillations, only moderate sealing and driving forces are required within the thermo-pump 100.

In embodiments, the thermo-pump 100 includes a shaft 108. The displacer 102 may be coupled to the shaft 108, such that linear motion of the shaft 108 drives the displacer 102. Further, the shaft 108 may be configured to be driven such that the thermo-pump 100 may be maintained as a sealed system (e.g., the shaft 108 remains within the sealed casing 104 during operation of the thermo-pump 100). For example, the shaft 108 may be magnetically driven. In this way, the shaft 108 may have one or more magnets 110 coupled to it.

The magnets 110 may correspond to one or more magnetic drivers 112. The magnetic drivers 112 may be located outside the thermo-pump 100 (e.g., external to the sealed casing 104) and translate linearly. The magnets 110 coupled to the shaft 108 may be attracted to the magnetic drivers 112 in such a way that the shaft 108 is translated in a manner corresponding to the translation of the magnetic drivers 112. The magnetic drivers 112 may cause periodic motion of the shaft 108 (e.g., and thus, the coupled displacer 102). For example, the shaft 108 may oscillate once per second.

In embodiments, the thermo-pump 100 includes one or more displacer rings 114. Each displacer ring 114 may be directly coupled to the displacer 102. The displacer rings 114 may further extend radially outward through the main casing volume 106. The displacer rings 114 may be made from low-expansion materials (e.g., materials whose size is not affected by changes in temperature). Further, the displacer rings 114 may be made from materials that exhibit both low-expansion and low-conductivity properties. For example, the displacer rings 114 may be made from materials possessing a low displacer ring thermal conductivity coefficient and/or a low displacer ring thermal expansion coefficient, such as, but not limited to, glass, machinable glass (e.g., MACOR), ceramic, or the like. As an illustration, MACOR has a thermal conductivity of 1.46 W/(K*m), compared to 15 W/(K*m) for stainless steel. Thus, the flow of heat between the top of the main casing volume 106 and the bottom of the main casing volume 106 may be significantly reduced, along with the possibility of expansion of the displacer rings 114, when using materials such as machinable glass.

In this way, the displacer rings 114 may be manufactured with a diameter slightly less than the diameter of the main casing volume 106 because the diameter of the displacer rings 114 will not change significantly with changes in temperature (e.g., the displacer rings 114 can be almost the same size as the main casing volume 106 without making contact due to expansion). It should be noted that thermal expansion of the shaft 108 may be minimal due to the small diameter of the shaft.

The displacer rings 114 may be located at various locations on the displacer 102. For example, the displacer rings 114 may be placed such that they are on one or more sides of the displacer 102 (e.g., above the displacer 102 or below the displacer 102). By way of another example, the displacer rings 114 may be placed at locations along the displacer 102 (e.g., the displacer 102 is made of two or more discrete pieces with one or more displacer rings 114 in between). By way of another example, the displacer rings 114 may be placed at one or more ends of the displacer 102.

In embodiments, the thermo-pump 100 includes an insert 116. The insert 116 may be a hollow cylinder and may fit concentrically within the sealed casing 104 (e.g., the insert forms a perimeter of the main casing volume 106). In this way, the displacer rings 114 may be configured to be slightly smaller than the insert 116 (e.g., the displacer rings 114 may be slightly smaller than the insert 116 instead of being slightly smaller than the main casing volume 106). The insert 116 may be made from a material that possesses a low insert thermal conductivity coefficient and/or a low insert thermal expansion coefficient. For example, the insert 116 may be made from materials such as, but not limited to, glass, machinable glass (e.g., MACOR), ceramic, or the like (e.g., the insert 116 may be made from the same material as the displacer rings 114 or a different material than the displacer rings 114). It is noted that the use of such an insert 116 may be possible because of the lack of pressure differences between areas in the main casing volume 106.

The insert 116, in addition to the displacer rings 114, may result in a stabilized gap 118 (e.g., a gap 118 not susceptible to significant expansion and/or contraction of materials because low-expansion materials were used for both sides). Further, the insert 116, in addition to the displacer rings 114, may result in enhanced insulation of the thermo-pump 100. Because the insert 116 and displacer rings 114 may both be made from low-conductivity materials, heat flow between the high temperature and low temperature areas of the main casing volume 106 may be reduced, as well as preventing heat escaping the thermo-pump 100 through the sealed casing 104. In this way, the addition of the insert 116 and/or the displacer rings 114 may increase the efficiency and/or performance of the thermo-pump 100.

Further, the displacer rings 114 and the insert 116 may minimize a gap 118 between the two. Thus, oscillating the displacer 102 and displacer rings 114 may force a gas to pass through the displacer 102 and exchange heat (e.g., the gas passes exclusively (or nearly exclusively) through the channels of the displacer 102 instead of flowing around the displacer 102). Further, the displacer rings 114 may isolate a hot end of the thermo-pump 100 from a cold end of the thermo-pump 100. The radial extension of the displacer rings 114 may compensate for the thermal expansion of the displacer 102 and other components of the thermo-pump 100 between a cold end of the main casing volume 106 and a hot end of the main casing volume.

The material used for the displacer rings 114 and/or the insert 116 may be selected so the thermal conductivity coefficient and/or the thermal expansion coefficient are below a threshold. For example, the threshold may be selected such that expansion of the displacer rings 114 and/or expansion of the insert 116 (e.g., expansion caused by temperature differences within the thermo-pump 100) do not result in contact with any solid surface (e.g., friction is prevented). Similarly, dimensions of the displacer rings 114 and/or the insert 116 may be selected based on the thermal conductivity coefficient and/or the thermal expansion coefficient to minimize expansion and maximize insulation of the thermo-pump 100.

Efficient operation of the thermo-pump 100 may be based on gas flowing through the channels of the displacer 102, and therefore through the regenerator (e.g., if the regenerator is made as a separate part), instead of around the displacer 102. Therefore, precise displacer rings 114 and/or inserts 116 may be used to minimize the gap 118. For example, a small gap 118 may result in nearly all of the gas in the main casing volume 106 flowing through the channels of the displacer 102, instead of around the displacer 102.

In embodiments, the thermo-pump 100 includes one or more secondary volumes 120 (e.g., the sealed casing 104 creates one or more secondary volumes 120 in addition to the main casing volume 106). For example, there may be a secondary volume 120 at the top of the thermo-pump 100 and a secondary volume 120 at the bottom of the thermo-pump 100. The secondary volumes 120 may be configured for the linear movement of the shaft 108, while the displacer 102 stays within the main casing volume 106.

In embodiments, the thermo-pump 100 includes one or more gas bearings 122. For example, each secondary volume 120 may include a gas bearing 122. The gas bearings 122 may be operated using the pressure gain generated by the thermo-pump 100.

In embodiments, the thermo-pump 100 includes one or more bushings 124. For example, each secondary volume 120 may be delineated from the main casing volume 106 by a bushing 124. The bushings 124 may form a tight fit with the casing 104 and/or the shaft 108. In this way, gases may be prevented from traveling between the main casing volume 106 and the secondary volumes 120. The bushings 124 may further divide (e.g., separate) the sealed casing 104 into the main casing volume 106 and the one or more secondary volumes 120.

In embodiments, the thermo-pump 100 includes a high-pressure supply 126 and a low-pressure supply 128. The pressures of the high-pressure supply 126 and the low-pressure supply 128 may be caused by the pressure gain caused by the thermo-pump 100. For example, the high-pressure supply 126 may be coupled to a high-pressure location of the thermo-pump 100, such as an output of the thermo-pump 100. By way of another example, the low-pressure supply 128 may be coupled to a low-pressure location of the thermo-pump 100, such as an input of the thermo-pump 100. High pressure gas may be supplied to the center of the gas bearing 122 (e.g., to form a thin layer of gas to prevent contact between the shaft 108 and the sealed casing 104).

It is noted that while the pressure in the main casing volume 106 varies between a high-pressure phase and a low pressure-pressure phase (e.g., the main casing volume 106 oscillates between a high-pressure phase and a low pressure-pressure phase), the pressure in the secondary volumes 120 may remain stabilized or constant (e.g., or nearly constant). The pressure in the secondary pressure volumes 120 may be kept constant because of the bushings 124. The bushings 124 may be configured such that they significantly reduce the flow of gases between the main casing volume 106 and the secondary volumes 120 (e.g., by reducing space for gases to flow between the main casing volume 106 and the secondary volumes 120 around the shaft). Because the secondary volume 120 has high pressure gas in it, the bushing 124 does not have to completely block the flow of gas between the main casing volume 106 and the secondary volumes 120. Instead, the bushings 124 only need to form a precise aperture, leaving a small space between the bushing 124 and the shaft 108 (e.g., to prevent friction between the shaft 108 and the bushing 124). Further, it is noted that the pressure drop may be up to the amount of pressure gain in the thermo-pump 100 and the gas flow may be significantly lower than the flow of the thermo-pump 100.

The gas bearings 122 may operate by producing a layer of a gas (e.g., high pressure gas) between two surfaces (e.g., the shaft 108 and the sealed casing 104). This layer of gas may prevent the two surfaces from making contract during linear translation of the shaft 108, such that the shaft 108 is able to operate in a frictionless environment (e.g., friction due to gas may be negligible below a certain speed threshold). Further, because there is no lubrication necessary (e.g., because there is no contact), the gas bearings 122 may be suitable for use in a clean environment. The bushings 124 may also result in stabilized pressures in the secondary volumes 120 (e.g., the volume in which the gas bearings 122 are located), which may make the gas bearings 122 suitable for operation in a high-pressure environment.

The high-pressure supply 126 and the low-pressure supply 128 may be used to operate the gas bearings 122 (e.g., the gas bearings 122 may operate on the pressure difference between input of the thermo-pump 100 and the output of the thermo-pump 100). The gas flow necessary for operation of the gas bearings 122 may be significantly less than the gas flow generated by the thermo-pump 100, and therefore, the gas bearings 122 may operate (e.g., produce a frictionless environment), while the thermo-pump 100 maintains its operational capabilities. The gas used within the thermo-pump 100 and for the gas bearings 122 may be any gas. For example, the gas may be argon (Ar).

FIG. 2 is a block diagram of a system 200, in accordance with one or more embodiments of the present disclosure.

In embodiments, the system 200 includes the thermo-pump 100.

In embodiments, the system 200 includes a broadband plasma (BBP) light source 202. However, it should be noted that the thermo-pump 100 as disclosed herein may be used with any device requiring operation of a thermo-pump 100. The thermo-pump 100 may be configured to provide a pressurized gas to the BBP light source 202. For example, the BBP light source 202 may be configured to operate in part based on high pressure gases. For instance, the BBP light source 202 may require pressurized gases to power a laser within the BBP light source 202. Thus, the thermo-pump 100 may provide such pressurized gas to the BBP light source 202. Such a configuration is disclosed in U.S. Pat. No. 11,450,521, issued on Sep. 20, 2022, as referenced previously herein, which is incorporated herein by reference in its entirety.

Further, the BBP light source 202 may be used for any use known in the art. For example, the BBP light source 202 may be used for metrology.

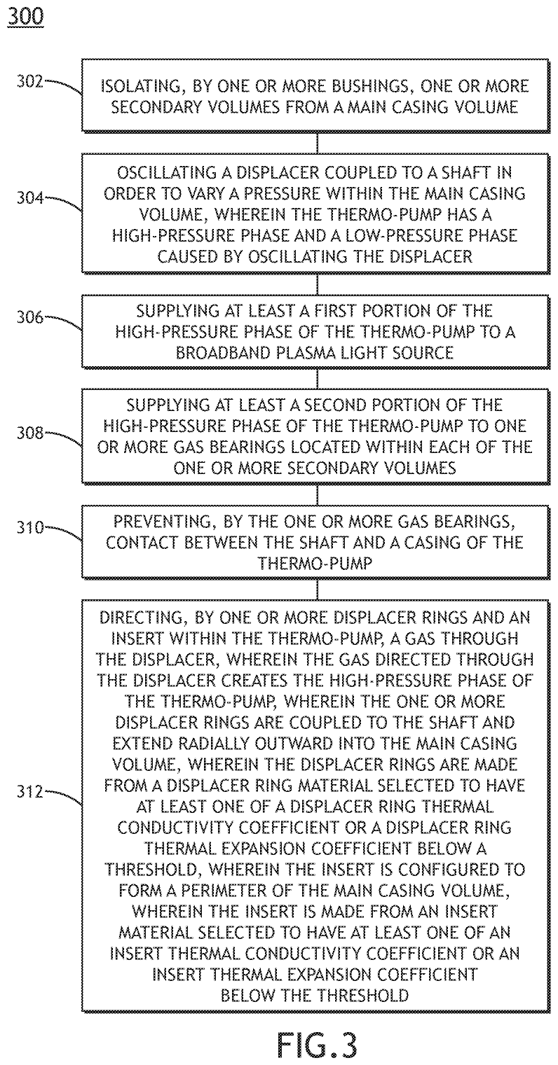

FIG. 3 is a flow diagram of a method 300, in accordance with one or more embodiments of the present disclosure. Applicant notes that the embodiments and enabling technologies described previously herein in the context of the thermo-pump 100 and/or the system 200 should be interpreted to extend to the method 300. It is further noted, however, that the method 300 is not limited to the architecture of the thermo-pump 100 and/or the system 200.

In embodiments, the method 300 includes a step 302 of isolating, by one or more bushings, one or more secondary volumes from a main casing volume. For example, the bushings may form a tight aperture around the shaft which penetrates through the one or more secondary volumes and the main casing volume. Because the secondary volumes may be under high pressure and there may be little space for gas to escape between the bushing and the shaft, the bushings may effectively isolate the one or more secondary volumes from the main casing volume.

In embodiments, the method 300 includes a step 304 of oscillating a displacer coupled to a shaft in order to vary a pressure within the main casing volume, wherein the thermo-pump has a high-pressure output caused by oscillating the displacer and a low-pressure input.

In embodiments, the method 300 includes a step 306 of supplying at least a first portion of the high-pressure output of the thermo-pump to a broadband plasma light source. For example, a large portion of the pressure gain generated via oscillating the displacer may be utilized by the broadband plasma light source.

In embodiments, the method 300 includes a step 308 of supplying at least a second portion of the high-pressure output of the thermo-pump to one or more gas bearings located within each of the one or more secondary volumes. For example, the second portion of the high-pressure output may be utilized by the gas bearings to create a thin film of gas. Further, gas escaping the thin film may be redirected into the low-pressure input of the thermo-pump and repressurized.

In embodiments, the method 300 includes a step 310 of preventing, by the one or more gas bearings, contact between the shaft and a casing of the thermo-pump. For example, the thin film of pressurized gas may be used to prevent contact between the shaft and the casing. In this way, the thermo-pump may operate without friction (e.g., negligible friction) between the shaft and the casing.

In embodiments, the method 300 includes a step 312 of directing, by one or more displacer rings and an insert within the thermo-pump, a gas through the displacer, wherein the gas directed through the displacer creates the high-pressure output of the thermo-pump, wherein the one or more displacer rings are coupled to the shaft and extend radially outward into the main casing volume, wherein the displacer rings are made from a displacer ring material selected to have at least one of a displacer ring thermal conductivity coefficient or a displacer ring thermal expansion coefficient below a threshold, wherein the insert is configured to form a perimeter of the main casing volume, wherein the insert is made from an insert material selected to have at least one of an insert thermal conductivity coefficient or an insert thermal expansion coefficient below the threshold. For example, the displacer and insert may be configured such that they minimize a gap within the main casing volume (e.g., a gap between the displacer ring and the insert. Minimizing such a gap may result in increased performance of the thermo-pump due to almost all of the gas within the thermo-pump flowing through the displacer.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected” or “coupled” to each other to achieve the desired functionality, and any two components capable of being so associated can also be viewed as being “couplable” to each other to achieve the desired functionality. Specific examples of couplable include but are not limited to physically interactable and/or physically interacting components and/or wirelessly interactable and/or wirelessly interacting components and/or logically interactable and/or logically interacting components.

It is believed that the present disclosure and many of its attendant advantages will be understood by the foregoing description, and it will be apparent that various changes may be made in the form, construction, and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. A thermo-pump, comprising:
a sealed casing, wherein the sealed casing is divided into a main casing volume and one or more secondary volumes;
a shaft, wherein the shaft is configured to be driven to cause the shaft to linearly oscillate within the sealed casing;
a displacer, wherein the displacer is coupled to the shaft and oscillates within the main casing volume based on oscillation of the shaft, wherein oscillation of the displacer creates a pressure gain between a high-pressure phase and a low-pressure phase;
one or more displacer rings, wherein the one or more displacer rings are coupled to the displacer and extend radially outward into the main casing volume, wherein the one or more displacer rings are made from a displacer ring material selected to have at least one of a displacer ring thermal conductivity coefficient or a displacer ring thermal expansion coefficient below a threshold;
an insert, wherein the insert is configured to form a perimeter of the main casing volume, wherein the insert is made from an insert material selected to have at least one of an insert thermal conductivity coefficient or an insert thermal expansion coefficient below the threshold, wherein the one or more displacer rings and the insert direct a gas through the displacer;
one or more bushings, wherein the one or more bushing separate the sealed casing into the main casing volume and the one or more secondary volumes; and
one or more gas bearings configured to prevent contact between the shaft and the sealed casing, wherein the one or more gas bearings are configured to operate based on the high-pressure phase and the low-pressure phase created by pressure oscillations caused by the oscillation of the displacer.

2. The thermo-pump of claim 1, wherein the shaft comprises one or more magnets coupled to the shaft.

3. The thermo-pump of claim 2, wherein the shaft is magnetically driven via one or more external magnetic drivers and the one or more magnets coupled to the shaft.

4. The thermo-pump of claim 1, wherein the one or more secondary volumes remains at a constant pressure.

5. The thermo-pump of claim 1, wherein the main casing volume varies between two or more pressures.

6. The thermo-pump of claim 1, wherein one or more of the insert or the one or more displacer rings are made from one of glass, machinable glass, or ceramic.

7. The thermo-pump of claim 1, wherein at least one of the one or more displacer rings are located at one or more ends of the displacer.

8. The thermo-pump of claim 1, wherein the displacer is formed from two or more discrete pieces.

9. The thermo-pump of claim 8, wherein at least one of the one or more displacer rings are located between the two or more discrete pieces of the displacer.

10. A system, comprising:
a broadband plasma light source; and
a thermo-pump the thermo-pump configured to provide pressurized gas to the broadband plasma light source, comprising:
a sealed casing, wherein the sealed casing is divided into a main casing volume and one or more secondary volumes;
a shaft, wherein the shaft is configured to be driven to cause the shaft to linearly oscillate within the sealed casing;
a displacer, wherein the displacer is coupled to the shaft and oscillates within the main casing volume based on oscillation of the shaft, wherein oscillation of the displacer creates a pressure gain between a high-pressure phase and a low-pressure phase;
one or more displacer rings, wherein the one or more displacer rings are coupled to the displacer and extend radially outward into the main casing volume, wherein the one or more displacer rings are made from a displacer ring material selected to have at least one of a displacer ring thermal conductivity coefficient or a displacer ring thermal expansion coefficient below a threshold;
an insert, wherein the insert is configured to form a perimeter of the main casing volume, wherein the insert is made from an insert material selected to have at least one of an insert thermal conductivity coefficient or an insert thermal expansion coefficient below the threshold, wherein the one or more displacer rings and the insert direct a gas through the displacer;
one or more bushings, wherein the one or more bushing separate the sealed casing into the main casing volume and the one or more secondary volumes; and
one or more gas bearings configured to prevent contact between the shaft and the sealed casing, wherein the one or more gas bearings are configured to operate based on the high-pressure phase and the low-pressure phase created by pressure oscillations caused by the oscillation of the displacer.

11. The thermo-pump of claim 10, wherein the shaft comprises one or more magnets coupled to the shaft.

12. The thermo-pump of claim 11, wherein the shaft is magnetically driven via one or more external magnetic drivers and the one or more magnets coupled to the shaft.

13. The thermo-pump of claim 10, wherein the one or more secondary volumes remains at a constant pressure.

14. The thermo-pump of claim 10, wherein the main casing volume varies between two or more pressures.

15. The thermo-pump of claim 10, wherein one or more of the insert or the one or more displacer rings are made from one of glass, machinable glass, or ceramic.

16. The thermo-pump of claim 10, wherein at least one of the one or more displacer rings are located at one or more ends of the displacer.

17. The thermo-pump of claim 10, wherein the displacer is formed from two or more discrete pieces.

18. The thermo-pump of claim 17, wherein at least one of the one or more displacer rings are located between the two or more discrete pieces of the displacer.

19. A method of thermo-pump operation, comprising:
isolating, by one or more bushings, one or more secondary volumes from a main casing volume;
oscillating a displacer coupled to a shaft in order to vary a pressure within the main casing volume, wherein the thermo-pump has a high-pressure phase and a low-pressure phase caused by oscillating the displacer;
supplying at least a first portion of the high-pressure phase of the thermo-pump to a broadband plasma light source;
supplying at least a second portion of the high-pressure phase of the thermo-pump to one or more gas bearings located within each of the one or more secondary volumes;
preventing, by the one or more gas bearings, contact between the shaft and a casing of the thermo-pump;
directing, by one or more displacer rings and an insert within the thermo-pump, a gas through the displacer, wherein the gas directed through the displacer creates the high-pressure phase of the thermo-pump, wherein the one or more displacer rings are coupled to the shaft and extend radially outward into the main casing volume, wherein the displacer rings are made from a displacer ring material selected to have at least one of a displacer ring thermal conductivity coefficient or a displacer ring thermal expansion coefficient below a threshold, wherein the insert is configured to form a perimeter of the main casing volume, wherein the insert is made from an insert material selected to have at least one of an insert thermal conductivity coefficient or an insert thermal expansion coefficient below the threshold.
